(19) United States
(12) Patent Application Publication
(10) Pub. No.: US 2014/0123639 A1
(43) Pub. Date: May 8, 2014

(54) HYDRAULIC DRIVE SYSTEM

(71) Applicants: Teruo Akiyama, Kokubunji-shi (JP); Noboru Iida, Chigasaki-shi (JP); Kenji Oshima, Koto-ku (JP); Koji Saito, Fujisawa-shi (JP)

(72) Inventors: Teruo Akiyama, Kokubunji-shi (JP); Noboru Iida, Chigasaki-shi (JP); Kenji Oshima, Koto-ku (JP); Koji Saito, Fujisawa-shi (JP)

(73) Assignee: KOMATSU LTD., Tokyo (JP)

(21) Appl. No.: 14/129,414

(22) PCT Filed: Aug. 13, 2012
(86) PCT No.: PCT/JP2012/070602

§ 371 Date: Dec. 26, 2013

(30) Foreign Application Priority Data
Aug. 24, 2011 (JP) 2011-182939

(51) Int. Cl. F15B 15/02

(52) U.S. Cl. CPC F15B 15/02
USPC 60/445

(57) ABSTRACT

A hydraulic driving system includes a hydraulic cylinder with a cylinder tube and a cylinder rod, a main pump, a hydraulic-fluid path, a charge pump, a stroke position detecting unit, and a pump control unit. The hydraulic-fluid path forms a closed circuit between a main pump and the hydraulic cylinder. The cylinder rod expands or contracts depending on how hydraulic fluid is supplied and exhausted to and from first and second chambers. The charge pump replenishes hydraulic-fluid in the hydraulic-fluid path. The pump control unit performs flow-rate reduction control in which the pump control unit reduces a suction flow rate so that a suction flow rate of the main pump is equal to or less than a maximum discharge flow rate of the charge pump when the stroke position becomes closer to a stroke end of the cylinder rod than a prescribed reference position during the flow rate reduction control.

### CROSS-REFERENCE TO RELATED APPLICATIONS

This application is a U.S. National stage application of International Application No. PCT/JP2012/070602, filed on Aug. 13, 2012. This U.S. National stage application claims priority under 35 U.S.C. §119(a) to Japanese Patent Application No. 2011-182939, filed in Japan on Aug. 24, 2011, the entire contents of which are hereby incorporated herein by reference.

### BACKGROUND

1. Field of the Invention

The present invention relates to a hydraulic drive system.

2. Background Information

Work machines such as a hydraulic excavator or a wheel loader are equipped with working implement driven by a hydraulic cylinder. Hydraulic fluid discharged from a hydraulic pump is supplied to the hydraulic cylinder. The inside of the cylinder tube is partitioned by a cylinder rod into a first chamber and a second chamber. The cylinder rod expands due to hydraulic fluid being supplied to the first chamber and hydraulic fluid being exhausted from the second chamber. The cylinder rod contracts due to hydraulic fluid being supplied to the second chamber and hydraulic fluid being exhausted from the first chamber.

The hydraulic fluid is supplied via a hydraulic circuit to the hydraulic cylinder. For example, Japan Patent Laid-open Patent Publication JP-A-2009-511831 describes a work machine equipped with a hydraulic closed circuit for supplying hydraulic fluid to the hydraulic cylinder. Potential energy of the working implement is regenerated due to the hydraulic circuit being a closed circuit. As a result, fuel consumption of a motor for driving the hydraulic pump can be reduced.

### SUMMARY

For example, when hydraulic fluid is supplied to a hydraulic motor instead of a hydraulic cylinder, via a closed hydraulic circuit, the hydraulic motor is able to continue running so long as the hydraulic fluid is supplied to the hydraulic motor. When the hydraulic motor is driven by an external force, the hydraulic motor is able to continue running so long as the external force acts on the hydraulic motor.

However, in the case of a hydraulic cylinder, when the cylinder rod reaches an end surface of the first chamber or the second chamber, the cylinder rod is not able to move any further. Accordingly, the flow rate of the hydraulic fluid returning from the hydraulic cylinder to the hydraulic pump becomes zero. Conversely, driving of the hydraulic pump continues due to the driving source. As a result, there is a shortage of hydraulic fluid being supplied to the hydraulic pump and the hydraulic pressure (called “suction pressure”) in the hydraulic-fluid path supplying hydraulic fluid to the hydraulic pump momentarily has negative pressure. Thus, aeration or cavitation occurs and damage to the hydraulic pump may occur.

However, a charge circuit is often installed with the closed hydraulic circuit. The charge circuit is provided for replenishing an amount of hydraulic fluid corresponding to oil leakage from the hydraulic pump. When the flow rate of the hydraulic fluid supplied to the hydraulic pump is insufficient, the suction pressure falls below the hydraulic pressure of the charge circuit (referred to as “charge pressure” hereinbelow) and hydraulic fluid is supplied from the charge circuit to the hydraulic-fluid path. Therefore, as described above, the insufficient flow rate may be compensated by the hydraulic fluid from the charge circuit when the flow rate of the hydraulic fluid being supplied to the hydraulic pump is insufficient.

However, in this case, when the hydraulic pump is being driven at the maximum rotation speed, hydraulic fluid having a flow rate of the same degree as the maximum suction flow rate of the hydraulic pump needs to be replenished from the charge circuit. Therefore, it is necessary to use a charge pump having a discharge capacity equivalent to or higher than that of the main hydraulic pump, in the charge circuit. The use of such a charge pump leads to an increase in energy loss since the charge pump generates excessive horsepower that does not contribute to the power transmission. Moreover, the space for disposing the charge pump in a vehicle may become very large due to the increase in the size of the charge pump.

An object of the present invention is to provide a hydraulic drive system that is able to suppress the generation of a supply shortage of hydraulic fluid to a hydraulic pump and suppress an increase in the size of the charge pump.

A hydraulic drive system according to a first aspect of the present invention includes a hydraulic cylinder, a main pump, a hydraulic-fluid path, a charge pump, a stroke position detecting unit, and a pump control unit. The hydraulic cylinder includes a cylinder tube and a cylinder rod. The cylinder rod includes a proximal end part that is inserted inside the cylinder tube. The cylinder rod partitions the inside of the cylinder tube into a first chamber and a second chamber. The cylinder rod expands due to hydraulic fluid being supplied to the first chamber and hydraulic fluid being exhausted from the second chamber. The cylinder rod contracts due to hydraulic fluid being supplied to the second chamber and hydraulic fluid being exhausted from the first chamber. The main pump is switchable between a state of supplying hydraulic fluid to the first chamber and sucking in hydraulic fluid from the second chamber, and a state of supplying hydraulic fluid to the second chamber and sucking in hydraulic fluid from the first chamber. The hydraulic-fluid path connects the first chamber and the main pump and connects the second chamber and the main pump. The hydraulic-fluid path configures a closed circuit between the main pump and the hydraulic cylinder. A charge pump replenishes the hydraulic-fluid in the hydraulic-fluid path. The stroke position detecting unit detects a stroke position. The stroke position is a position of the proximal end part of the cylinder rod inside the cylinder tube. A pump control unit performs flow-rate reduction control. The pump control unit reduces a suction flow rate of the main pump so that the suction flow rate is equal to or less than a maximum discharge flow rate of the charge pump when the stroke position is closer to a stroke end of the cylinder rod than a prescribed reference position during the flow rate reduction control.

The hydraulic drive system according to a second aspect of the present invention is related to the hydraulic drive system of the first aspect, wherein the pump control unit controls the suction flow rate in accordance with flow rate reduction characteristics that prescribe a change in the suction flow rate with respect to the stroke position in the flow rate reduction control. The flow rate reduction characteristics have a reduction portion in which the suction flow rate becomes smaller as the stroke position approaches the stroke end. A change rate of the suction flow rate in the reduction portion of the flow rate reduction characteristics does not change regardless of the suction flow rate before execution of the flow rate reduction control.

The hydraulic drive system according to a third aspect of the present invention is related to the hydraulic drive system of the second aspect, wherein the stroke position when the reduction of the suction flow rate has started is closer to the stroke end in correspondence to a reduction in the size of the suction flow rate before the execution of the flow rate reduction control.

The hydraulic drive system according to a fourth aspect of the present invention is related to the hydraulic drive system of the first aspect, wherein the pump control unit controls the suction flow rate in accordance with flow rate reduction characteristics that prescribe a change in the suction flow rate with respect to the stroke position in the flow rate reduction control. The flow rate reduction characteristics have a reduction portion in which the suction flow rate is reduced as the stroke position approaches the stroke end. A change rate of the suction flow rate in the reduction portion of the flow rate reduction characteristics changes in response to the suction flow rate before the execution of the flow rate reduction control.

The hydraulic drive system according to a fifth aspect of the present invention is related to the hydraulic drive system of the fourth aspect, wherein a change rate of the suction flow rate in the reduction portion of the flow rate reduction characteristics becomes smaller in correspondence to a reduction in the size of the suction flow rate before the execution of the flow rate reduction control.

The hydraulic drive system according to a sixth aspect of the present invention is related to the hydraulic drive system of the fifth aspect, wherein the stroke position when the reduction of the suction flow rate has started is the same regardless of the suction flow rate before the execution of the flow rate reduction control.

The hydraulic drive system according to a seventh aspect of the present invention is related to the hydraulic drive system of any one of the second to sixth aspects, wherein the suction flow rate is maintained at a prescribed flow rate equal to or less than the maximum discharge flow rate of the charge pump in a prescribed range of the stroke position that includes the stroke end in the flow rate reduction characteristics.

The hydraulic drive system according to an eighth aspect of the present invention is related to any of the hydraulic drive systems according to the second to sixth aspects, wherein the suction flow rate becomes smaller as the stroke position approaches the stroke end, and the suction flow rate reaches zero when the stroke position reaches the stroke end in the flow rate reduction characteristics.

The hydraulic drive system according to a ninth aspect of the present invention is related to any of the hydraulic drive systems according to the second to sixth aspects, wherein the suction flow rate becomes smaller as the stroke position approaches the stroke end, and the suction flow rate reaches zero before the stroke position reaches the stroke end, in the flow rate reduction characteristics.

The hydraulic drive system according to a tenth aspect of the present invention is related to any one of the second to sixth aspects, and further includes an expansion/contraction determining unit. The expansion/contraction determining unit determines whether the hydraulic cylinder is operating by expanding or contracting. When the hydraulic cylinder is expanding, the pump control unit controls the suction flow rate in accordance with the flow rate reduction characteristics for an expansion operation in the flow rate reduction control. When the hydraulic cylinder is contracting, the pump control unit controls the suction flow rate in accordance with the flow rate reduction characteristics for a contraction operation in the flow rate reduction control.

The hydraulic drive system according to an eleventh aspect of the present invention is related to the hydraulic drive system of the tenth aspect, and further includes an operating member for operating the hydraulic cylinder. The expansion/contraction determining unit determines whether the cylinder rod is moving in an expansion direction or a contraction direction from detection results of the stroke position detecting unit. The expansion/contraction determining unit determines that the cylinder rod in is the expansion operation or the contraction operation when the moving direction of the cylinder rod matches an operation direction of the operating member.

The hydraulic drive system according to a twelfth aspect of the present invention is related to the hydraulic drive system of the tenth aspect, wherein the flow rate of hydraulic fluid returning from the hydraulic cylinder to the main pump during a contraction operation is larger than a flow rate of hydraulic fluid returning from the hydraulic cylinder to the main pump during an expansion operation.

The pump control unit in the hydraulic drive system according to the first aspect of the present invention reduces the suction flow rate so that the suction flow rate of the main pump is equal to or less than the maximum discharge flow rate of the charge pump when the stroke position approaches the stroke end of the cylinder rod in the flow rate reduction control. When the cylinder rod reaches the stroke end and the suction pressure is reduced, the shortage of hydraulic fluid is replenished by hydraulic fluid from the charge pump. Since the suction flow rate of the main pump is reduced by the flow rate reduction control at this time, the amount of hydraulic fluid required for replenishing is smaller. Therefore, the shortage of hydraulic fluid can be replenished with hydraulic fluid from the charge pump without making the charge pump larger. As a result, a hydraulic drive system can be provided that is able to suppress the generation of a supply shortage of hydraulic fluid to a hydraulic pump and suppress an increase in the size of a charge pump.

Since the suction flow rate is reduced in accompaniment to the stroke position approaching the stroke end in the hydraulic drive system according to the second aspect of the present invention, it can be suppressed that the movement of the hydraulic cylinder become slow drastically. Moreover, since the change rate of the suction flow rate in the reduction portion of the flow rate reduction characteristics does not change regardless of the suction flow rate before the execution of the flow rate reduction control, variations in changes of the operation speed of the hydraulic cylinder can be suppressed.

The flow rate reduction characteristics can be set easily so that the change rate of the suction flow rate in the reduction portion of the flow rate reduction characteristics does not change regardless of the suction flow rate before the execution of the flow rate reduction control.

The suction flow rate is reduced in accompaniment to the stroke position approaching the stroke end in the hydraulic drive system according to the fourth aspect of the present invention. As a result, it can be suppressed that the movement of the hydraulic cylinder become slow drastically. Since the change rate of the suction flow rate in the reduction portion of the flow rate reduction characteristics changes in response to the suction flow rate before the execution of the flow rate reduction control, the suction flow rate can be reduced at a suitable change rate in accordance with conditions before the execution of the flow rate reduction control.

The suction flow rate can be reduced at a change rate suitable to the conditions before the execution of the flow rate reduction control in the hydraulic drive system according to the fifth aspect of the present invention.

Since the stroke position when the reduction of the suction flow rate is started is the same regardless of the suction flow rate before the execution of the flow rate reduction control in the hydraulic drive system according to the sixth aspect of the present invention, variation in the timing when the movement of the hydraulic cylinder become slow can be suppressed.

Hydraulic fluid at a prescribed flow rate is sucked into the main pump and discharged from the main pump even when the stroke position reaches the stroke end in the hydraulic drive system according to the seventh aspect of the present invention. Therefore, the proximal end part of the cylinder rod moves at a prescribed speed and touches the end part on the inside surface of the cylinder tube. As a result, the operator is able to easily know when the stroke position reaches the stroke end.

The suction flow rate reaches zero when the stroke position reaches the stroke end in the hydraulic drive system according to the eighth aspect of the present invention. As a result, the proximal end part of the cylinder rod makes contact with the end part of the inside surface of the cylinder tube in a gentle manner.

The suction flow rate reaches zero before the stroke position reaches the stroke end in the hydraulic drive system according to the ninth aspect of the present invention. As a result, the proximal end part of the cylinder rod makes contact with the end part of the inside surface of the cylinder tube in a gentle manner. Moreover, the suction flow rate is reduced to zero in a more reliable manner at the point in time that the stroke position reaches the stroke end.

The control of the suction flow rate can be accomplished according to different flow rate reduction characteristics during a hydraulic cylinder contraction and an expansion in the hydraulic drive system according to the tenth aspect of the present invention. As a result, the suction flow rate can be controlled with flow rate reduction characteristics that suit the operating state of the hydraulic cylinder.

Whether the cylinder rod is expanding or contracting is determined due to both the operating direction of the operating member and the moving direction of the cylinder rod in the hydraulic drive system according to the eleventh aspect of the present invention. As a result, suitable flow rate reduction characteristics can be selected even if for example the hydraulic cylinder moves in a direction opposite the operating direction of the operating member due to inertia immediately after the operating direction of the operating member is switched to the opposite direction.

The flow rate of hydraulic fluid returning from the hydraulic cylinder to the main pump during a contraction operation is larger than the flow rate of hydraulic fluid returning from the hydraulic cylinder to the main pump during an expansion operation in the hydraulic drive system according to a twelfth aspect of the present invention. As a result, a suction flow rate control can be performed that is suitable for different hydraulic fluid return flow rates according to whether the flow rate reduction characteristics during a contraction or the flow rate reduction characteristics during an expansion are used.

### BRIEF DESCRIPTION OF DRAWINGS

FIG. 1 is a block diagram of a configuration of a hydraulic drive system according to an embodiment of the present invention.

FIG. 2 is a flow chart describing control for suction flow rate in the hydraulic drive system.

FIG. 3 illustrates graphs describing flow rate reduction characteristics in the hydraulic drive system.

FIG. 4 illustrates graphs describing flow rate reduction characteristics according to a first modified example.

FIG. 5 illustrates graphs describing flow rate reduction characteristics according to a second modified example.

FIG. 6 illustrates graphs describing flow rate reduction characteristics according to a third modified example.

FIG. 7 is a block diagram of a configuration of a hydraulic drive system according to another embodiment of the present invention.

### DETAILED DESCRIPTION OF EMBODIMENT(S)

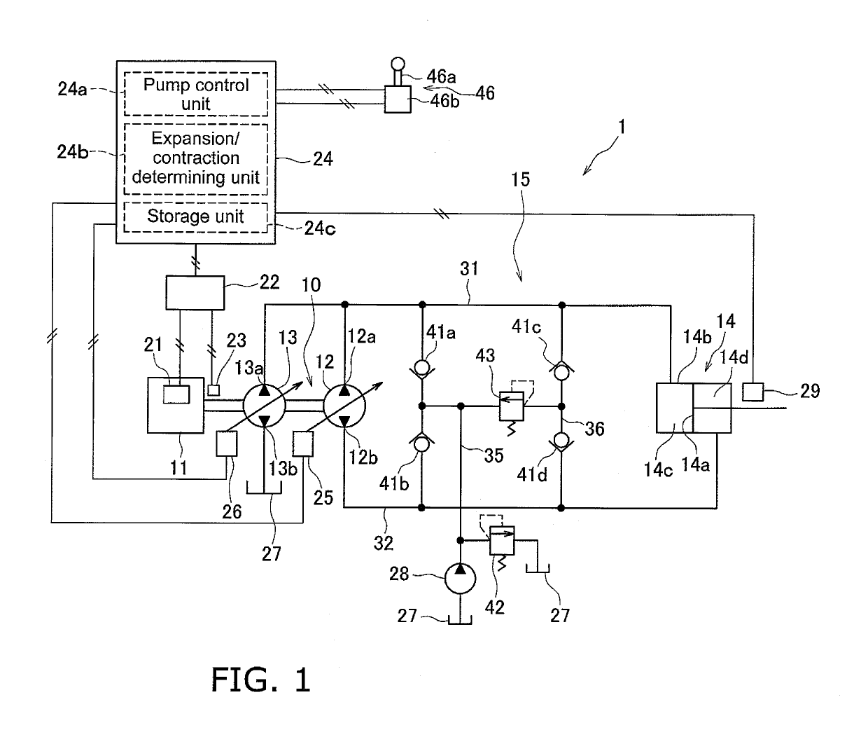

A hydraulic drive system according to an embodiment of the present invention shall be explained in detail with reference to the figures. FIG. 1 is a block diagram of a configuration of a hydraulic drive system 1 according to an embodiment of the present invention. The hydraulic drive system 1 is installed on a work machine such as a hydraulic excavator, a wheel loader, or a bulldozer. The hydraulic drive system 1 includes an engine 11, a main pump 10, a hydraulic cylinder 14, a hydraulic-fluid path 15, and a pump controller 24.

The engine 11 drives a first hydraulic pump 12 and a second hydraulic pump 13. The engine 11 is an example of a driving source in the present invention. The engine 11 is a diesel engine, for example, and the output of the engine 11 is controlled by adjusting an injection amount of fuel from a fuel injection device 21. The adjustment of the fuel injection amount is performed by the engine controller 22 controlling the fuel injection device 21. An actual rotation speed of the engine 11 is detected by a rotation speed sensor 23. The detection signal of the rotation speed sensor 23 is input into the engine controller 22 and the pump controller 24.

The main pump 10 is driven by the engine 11 to discharge hydraulic fluid. The main pump 10 includes the first hydraulic pump 12 and the second hydraulic pump 13. The hydraulic fluid discharged from the main pump 10 is supplied to the hydraulic cylinder 14.

The first hydraulic pump 12 is a variable displacement hydraulic pump. The discharge flow rate of the first hydraulic pump 12 is controlled by controlling a tilt angle of the first hydraulic pump 12. In other words, the suction flow rate of the first hydraulic pump 12 is controlled by controlling a tilt angle of the first hydraulic pump 12. The tilt angle of the first hydraulic pump 12 is controlled by a first pump-flow-rate control unit 25. The first pump-flow-rate control unit 25 controls the discharge flow rate of the first hydraulic pump 12 by controlling the tilt angle of the first hydraulic pump 12 on the basis of a command signal from the pump controller 24. The first hydraulic pump 12 is a two-directional discharge hydraulic pump.

Specifically, the first hydraulic pump 12 has a first pump port 12a and a second pump port 12b. The first hydraulic pump 12 is switchable between a first discharge state and a second discharge state. Hydraulic fluid is supplied to the second pump port 12b in the first hydraulic pump 12, and the first hydraulic pump 12 discharges hydraulic fluid from the first pump port 12a in the first discharge state. The first hydraulic pump 12 supplies hydraulic fluid to the first pump port 12a and discharges hydraulic fluid from the second pump port 12b in the second discharge state.

The second hydraulic pump 13 is a variable displacement hydraulic pump. The discharge flow rate of the second hydraulic pump 13 is controlled by controlling the tilt angle of the second hydraulic pump 13. In other words, the suction flow rate of the second hydraulic pump 13 is controlled by controlling the tilt angle of the second hydraulic pump 13. The tilt angle of the second hydraulic pump 13 is controlled by a second pump-flow-rate control unit 26. The second pump-flow-rate control unit 26 controls the discharge flow rate of the second hydraulic pump 13 by controlling the tilt angle of the second hydraulic pump 13 on the basis of a command signal from the pump controller 24. The second hydraulic pump 13 is a two-directional discharge hydraulic pump.

Specifically, the second hydraulic pump 13 has a first pump port 13a and a second pump port 13b. The second hydraulic pump 13 is switchable between a first discharge state and a second discharge state in the same way as the first hydraulic pump 12. Hydraulic fluid is supplied to the second pump port 13b in the second hydraulic pump 13, and the second hydraulic pump 13 discharges hydraulic fluid from the first pump port 13a in the first discharge state. Hydraulic fluid is supplied to the first pump port 13a in the second hydraulic pump 13, and the second hydraulic pump 13 discharges hydraulic fluid from the second pump port 13b in the second discharge state.

The hydraulic cylinder 14 is driven by hydraulic fluid discharged from the first hydraulic pump 12 and the second hydraulic pump 13. The hydraulic cylinder 14 drives working implement such as a boom, an arm, or a bucket. The hydraulic cylinder 14 includes a cylinder rod 14a and a cylinder tube 14b. The cylinder rod 14a partitions the inside of the cylinder tube 14b into a first chamber 14c and a second chamber 14d. The cylinder rod 14a includes a proximal end part that is inserted inside the cylinder tube 14b.

The hydraulic cylinder 14 expands and contracts by switching between the supply and exhaust of hydraulic fluid to and from the first chamber 14c and the second chamber 14d. Specifically, the hydraulic cylinder 14 expands due to the supply of hydraulic fluid into the first chamber 14c and the exhaust of hydraulic fluid from the second chamber 14d. The hydraulic cylinder 14 contracts due to the supply of hydraulic fluid into the second chamber 14d and the exhaust of hydraulic fluid from the first chamber 14c. A pressure receiving area of the cylinder rod 14a in the first chamber 14c is greater than a pressure receiving area of the cylinder rod 14a in the second chamber 14d. Therefore, when the hydraulic cylinder 14 is expanded, more hydraulic fluid is supplied to the first chamber 14c than is exhausted from the second chamber 14d. When the hydraulic cylinder 14 is contracted, more hydraulic fluid is exhausted from the first chamber 14c than is supplied to the second chamber 14d.

The hydraulic-fluid path 15 is connected to the first hydraulic pump 12, the second hydraulic pump 13, and the hydraulic cylinder 14. The hydraulic-fluid path 15 connects the first chamber 14c and the first pump port 12a, and connects the second chamber 14d and the second pump port 12b. The hydraulic-fluid path 15 configures a closed circuit between the main pump 10 and the hydraulic cylinder 14.

Specifically, the hydraulic-fluid path 15 includes a first path 31 and a second path 32. The first path 31 connects the first chamber 14c of the hydraulic cylinder 14 with the first pump port 12a of the first hydraulic pump 12. The first path 31 is a path for supplying hydraulic fluid to the first chamber 14c of the hydraulic cylinder 14, or for recovering hydraulic fluid from the first chamber 14c of the hydraulic cylinder 14. The first path 31 is connected to the first pump port 13a of the second hydraulic pump 13. Therefore, hydraulic fluid is supplied to the first path 31 from both the first hydraulic pump 12 and the second hydraulic pump 13.

The second path 32 is connected to the second chamber 14d of the hydraulic cylinder 14 and to the second pump port 12b of the first hydraulic pump 12. The second path 32 is a path for supplying hydraulic fluid to the second chamber 14d of the hydraulic cylinder 14, or for recovering hydraulic fluid from the second chamber 14d of the hydraulic cylinder 14. The second pump port 13b of the second hydraulic pump 13 is connected to a hydraulic fluid tank 27. Therefore, hydraulic fluid from the first hydraulic pump 12 is supplied to the second path 32. The hydraulic-fluid path 15 configures a closed circuit between the main pump 10 and the hydraulic cylinder 14 with the first path 31 and the second path 32.

The hydraulic drive system 1 further includes a charge pump 28. The charge pump 28 is a hydraulic pump for replenishing hydraulic fluid to the hydraulic-fluid path 15. The charge pump 28 is driven by the engine 11 to discharge hydraulic fluid. The charge pump 28 is a fixed displacement hydraulic pump.

The hydraulic-fluid path 15 further includes a charge path 35. The charge path 35 connects the charge pump 28 with the first path 31. The charge path 35 also connects the charge pump 28 with the second path 32. Specifically, the charge path 35 is connected to the first path 31 via a check valve 41a. The check valve 41a is open when the hydraulic pressure of the first path 31 is lower than the hydraulic pressure of the charge path 35. The charge path 35 is connected to the second path 32 via a check valve 41b. The check valve 41b is open when the hydraulic pressure of the second path 32 is lower than the hydraulic pressure of the charge path 35.

The charge path 35 is also connected to the hydraulic fluid tank 27 via a charge relief valve 42. The charge relief valve 42 maintains the hydraulic pressure in the charge path 35 at a prescribed charge pressure. When the hydraulic pressure of the first path 31 or the second path 32 becomes lower than the hydraulic pressure in the charge path 35, hydraulic fluid from the charge pump 28 is supplied to the first path 31 or the second path 32 via the charge path 35. As a result, the hydraulic pressure in the first path 31 and the second path 32 is maintained at a prescribed pressure or greater.

The hydraulic-fluid path 15 further includes a relief path 36. The relief path 36 is connected to the first path 31 via a check valve 41c. The check valve 41c is open when the hydraulic pressure of the first path 31 is higher than the hydraulic pressure of the relief path 36. The relief path 36 is connected to the second path 32 via a check valve 41d. The check valve 41c is open when the hydraulic pressure of the second path 32 is higher than the hydraulic pressure of the relief path 36. The relief path 36 is connected to the charge path 35 via the relief valve 43. The relief valve 43 maintains the pressure of the relief path 36 at a pressure equal to or less than a prescribed relief pressure. As a result, the hydraulic pressure of the first path 31 and the second path 32 is maintained at a prescribed pressure equal to or less than the prescribed relief pressure.

When the hydraulic cylinder 14 is expanded, the first hydraulic pump 12 and the second hydraulic pump 13 are driven in a first discharge state. As a result, the main pump 10 enters a state of supplying hydraulic fluid to the first chamber 14c and sucking in hydraulic fluid from the second chamber 14d. Specifically, hydraulic fluid discharged from the first pump port 12a of the first hydraulic pump 12 and from the first pump port 13a of the second hydraulic pump 13 passes through the first path 31 and is supplied to the first chamber 14c of the hydraulic cylinder 14.

The hydraulic fluid in the second chamber 14d of the hydraulic cylinder 14 passes through the second path 32 and is recovered in the second pump port 12b of the first hydraulic pump 12. As a result, the hydraulic cylinder 14 expands.

When the hydraulic cylinder 14 is contracted, the first hydraulic pump 12 and the second hydraulic pump 13 are driven in the second discharge state. As a result, the main pump 10 enters a state of supplying hydraulic fluid to the second chamber 14d and sucking in hydraulic fluid from the first chamber 14c. Specifically, hydraulic fluid discharged from the second pump port 12b of the first hydraulic pump 12 passes through the second path 32 to be supplied to the second chamber 14d of the hydraulic cylinder 14. The hydraulic fluid in the first chamber 14c of the hydraulic cylinder 14 passes through the first path 31 to be recovered in the first pump port 12a of the first hydraulic pump 12 and in the first pump port 13a of the second hydraulic pump 13. As a result, the hydraulic cylinder 14 contracts.

The hydraulic drive system 1 further includes a stroke position detecting unit 29. The stroke position detecting unit 29 detects a stroke position. The stroke position is a position of the proximal end part of the cylinder rod 14a inside the cylinder tube 14b. The stroke position detecting unit 29 detects, for example, a swing angle of a working implement member such as the boom, the arm, or the bucket driven by the hydraulic cylinder 14. The below mentioned pump controller 24 is able to calculate the stroke position from the swing angle of the working implement member. The stroke position detecting unit 29 may also be a sensor for detecting the stroke amount of the cylinder rod 14a.

The hydraulic drive system 1 further includes an operating device 46. The operating device 46 includes an operating member 46a and an operation detecting unit 46b. The operating member 46a is operated by an operator in order to command various types of operations of the work machine. For example, when the hydraulic cylinder 14 is a boom cylinder for driving a boom, the operating member 46a is a boom operating lever for operating the boom. Specifically, the operating member 46 is operated by the operator for operating the hydraulic cylinder 14.

The operating member 46a can be operated in two directions: a direction for expanding the hydraulic cylinder 14 from a neutral position, and a direction for contracting the hydraulic cylinder 14 from the neutral position. The operation detecting unit 46b detects the operation amount and the operation direction of the operating member 46a. The operation detecting unit 46b is a sensor for detecting a position of the operating member 46a for example. When the operating member 46 is positioned in the neutral position, the operation amount of the operating member 46a is zero. Detection signals that indicate the operation amount and the operation direction of the operating member 46a are input from the operation detecting unit 46b to the pump controller 24.

The engine controller 22 controls the output of the engine 11 by controlling the fuel injection device 21. Engine output torque characteristics determined on the basis of a set target engine rotation speed and a work mode are mapped and stored in the engine controller 22. The engine output torque characteristics indicate the relationship between the output torque and the rotation speed of the engine 11. The engine controller 22 controls the output of the engine 11 on the basis of the engine output torque characteristics.

The pump controller 24 controls the first hydraulic pump 12 and the second hydraulic pump 13 in response to the operation amount of the operating member 46a. The pump controller 24 includes a pump control unit 24a, an expansion/contraction determining unit 24b, and a storage unit 24c. The pump control unit 24a and the expansion/contraction determining unit 24b may be realized by a calculation device such as a CPU or the like. The storage unit 24c may be realized by a recording device such as a RAM, a ROM, a hard disk, a flash memory, or the like. The storage unit 24c stores information for controlling the first hydraulic pump 12 and the second hydraulic pump 13.

The pump controller 24 calculates a target flow rate of the hydraulic fluid supplied to the hydraulic cylinder 14 in response to the operation amount of the operating member 46a. The pump control unit 24a executes a flow rate reduction control. The flow rate reduction control is a control for reducing a suction flow rate so that the suction flow rates of the first hydraulic pump 12 and the second hydraulic pump 13 are equal to or less than a maximum discharge flow rate of the charge pump 35 when the stroke position becomes closer to a stroke end of the cylinder rod 14a than a prescribed reference position. The flow rate reduction control is described in detail below.

The expansion/contraction determining unit 24b determines whether the hydraulic cylinder is operating by expanding or contracting. The expansion/contraction determining unit 24b determines whether the cylinder rod is moving in an expansion direction or a contraction direction from detection results of the stroke position detecting unit 29 and detection results of the operation detecting unit 46b. The expansion/contraction determining unit 24b determines that the cylinder rod 14a in is an expansion operation or a contraction operation when the moving direction of the cylinder rod 14a matches an operation direction of the operating member 46a.

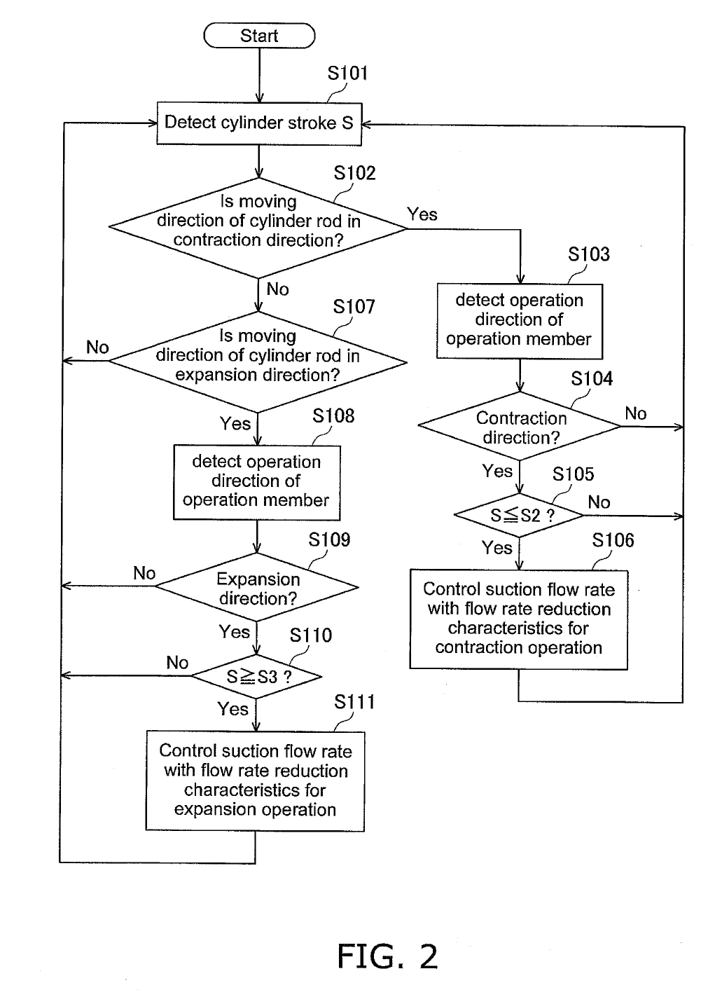

Processing during the flow rate reduction control is described hereinbelow with reference to the flow chart in FIG. 2.

In step S101, a stroke position S is detected by the stroke position detecting unit 29. In step S102, a determination is made as to whether the moving direction of the cylinder rod 14a is in the contraction direction. For example, a determination is made as to whether the moving direction of the cylinder rod 14a is in the contraction direction on the basis of a change in the cylinder position. The stroke position S is represented by a value that becomes larger as the stroke position S approaches the stroke end during an expansion operation with the stroke end being zero during a contraction operation. The process advances to step S103 of the moving direction of the cylinder rod 14a is in the contraction direction.

In step S103, the operation direction of the operating member 46a is detected by the operation detecting unit 46b. Next, in step S104, a determination is made as to whether the operation direction of the operating member 46a is the contraction direction. The process advances to step S105 if the operation direction of the operating member 46a is the contraction direction. In step S105, a determination is made as to whether the stroke position S is equal to or less than a reduction start position S2 during the contraction operation. The process advances to step S106 if the stroke position S is equal to or less than the reduction start position S2.

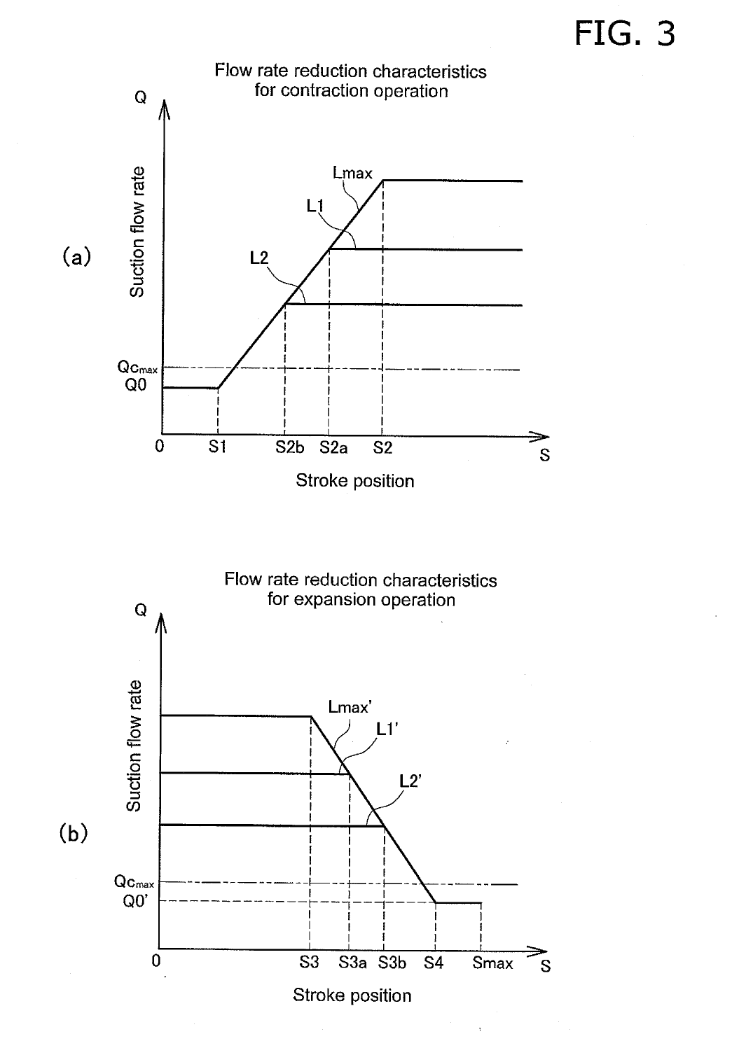

In step S106, the suction flow rate of the first hydraulic pump 12 and the second hydraulic pump 13 is controlled according to the flow rate reduction characteristics during a contraction operation. The flow rate reduction characteristics prescribe changes in the suction flow rate with respect to the stroke position S. As illustrated in FIG. 3(a), the flow rate reduction characteristics prescribe changes in the suction flow rate with respect to the stroke position S so that the suction flow rate of the first hydraulic pump 12 and the second hydraulic pump 13 when the stroke position S becomes closer to the stroke end on the contraction side than a reference position S1 during the contraction operation, is equal to or less than a maximum discharge flow rate Qcmax of the charge pump 28. FIG. 3(a) illustrates changes in the total suction flow rate of the first hydraulic pump 12 and the second hydraulic pump 13. The flow rate reduction control during a contraction operation is described in detail below.

When a determination is made in step S104 that the operation direction of the operating member 46a is not the contraction direction, the process returns to step S101. When a determination is made in step S105 that the stroke position S is not equal to or less than the reduction start position S2 during a contraction operation, the process returns to step S101.

The process advances to step S107 if it is determined in step S102 that the moving direction of the cylinder rod 14a is not in the contraction direction. In step S107, a determination is made as to whether the moving direction of the cylinder rod 14a is in the expansion direction. The process advances to step S108 if the moving direction of the cylinder rod 14a is in the expansion direction.

In step S108, the operation direction of the operating member 46a is detected by the operation detecting unit 46b. Next, in step S109, a determination is made as to whether the operation direction of the operating member 46a is the expansion direction. The process advances to step S110 if the operation direction of the operating member 46a is the expansion direction. In step S110, a determination is made as to whether the stroke position S is equal to or greater than a reduction start position S3 during the expansion operation. The process advances to step S111 if the stroke position S is equal to or greater than the reduction start position S3.

In step S111, the suction flow rate is controlled with the flow rate reduction characteristics for an expansion operation illustrated in FIG. 3(b). As illustrated in FIG. 3(b), the flow rate reduction characteristics prescribe changes in the suction flow rate with respect to the stroke position S so that the suction flow rate of the first hydraulic pump 12 when the stroke position S becomes closer to the stroke end Smax on the expansion side than a reference position S4 during the expansion operation, is equal to or less than a maximum discharge flow rate Qcmax of the charge pump 28.

FIG. 3(b) illustrates changes in the suction flow rate of the first hydraulic pump 12. The flow rate reduction control during an expansion operation is described in detail below. The process returns to step S101 if it is determined in step S107 that the moving direction of the cylinder rod 14a is not in the expansion direction. When a determination is made in step S109 that the operation direction of the operating member 46a is not the expansion direction, the process returns to step S101. Moreover, when a determination is made in step S110 that the stroke position S is not equal to or greater than a reduction start position S3 during an expansion operation, the process returns to step S101.

As described above, the suction flow rate is controlled with the flow rate reduction characteristics during a contraction operation illustrated in FIG. 3(a) when the hydraulic cylinder 14 is in a contraction operation. The suction flow rate is controlled with the flow rate reduction characteristics during an expansion operation illustrated in FIG. 3(b) when the hydraulic cylinder 14 is in the expansion operation.

In FIG. 3(a), Lmax indicates the flow rate reduction characteristics when the suction flow rate before the execution of the flow rate reduction control is the maximum flow rate. L1 indicates the flow rate reduction characteristics when the suction flow rate before the execution of the flow rate reduction control is a first flow rate that is less than the maximum flow rate. L2 indicates the flow rate reduction characteristics when the suction flow rate before the execution of the flow rate reduction control is a second flow rate that is less than the first flow rate.

The flow rate reduction characteristics have reduction portions in which the suction flow rate becomes smaller as the stroke position S approaches the stroke end. The slopes of the reduction portions of the flow rate reduction characteristics match each other. A change rate of the suction flow rate in the reduction portion of the flow rate reduction characteristics does not change regardless of the suction flow rate before the execution of the flow rate reduction control. However, the stroke positions S when the reduction of the suction flow rates has started in each of the flow rate reduction characteristics are different from each other. Specifically, the reduction start positions approach closer to the stroke end during the contraction operation as the suction flow rate before the execution of the flow rate reduction control becomes smaller. Specifically, a reduction start position S2a of the flow rate reduction characteristic L1 is smaller than a reduction start position S2 of the flow rate reduction characteristics Lmax. A reduction start position S2b of the flow rate reduction characteristic L2 is smaller than the reduction start position S2a of the flow rate reduction characteristics L1.

The suction flow rate is maintained at a prescribed flow rate Q0 in a prescribed range (between stroke positions 0 to S1) of the stroke position S that includes the stroke end during the contraction operation in the flow rate reduction characteristics. The prescribed flow rate Q0 is equal to or less than the maximum discharge flow rate Qcmax of the charge pump 28 and greater than zero.

In FIG. 3(b), Lmax′ indicates the flow rate reduction characteristics when the suction flow rate before the execution of the flow rate reduction control is the maximum flow rate. L1′ indicates the flow rate reduction characteristics when the suction flow rate before the execution of the flow rate reduction control is the first flow rate that is less than the maximum flow rate. L2′ indicates the flow rate reduction characteristics when the suction flow rate before the execution of the flow rate reduction control is the second flow rate that is less than the first flow rate.

The flow rate reduction characteristics have reduction portions in which the suction flow rate becomes smaller as the stroke position S approaches the stroke end. The slopes of the reduction portions of the flow rate reduction characteristics match each other. A change rate of the suction flow rate in the reduction portion of the flow rate reduction characteristics does not change regardless of the suction flow rate before the execution of the flow rate reduction control. However, the stroke positions S when the reduction of the suction flow rates has started in each of the flow rate reduction characteristics are different from each other. Specifically, the reduction start positions approach closer to the stroke end during the expansion operation as the suction flow rate before the execution of the flow rate reduction control becomes smaller. Specifically, a reduction start position S3a of the flow rate reduction characteristic L1′ is larger than a reduction start position S3 of the flow rate reduction characteristics Lmax′. A reduction start position S3b of the flow rate reduction characteristic L2′ is larger than the reduction start position S3a of the flow rate reduction characteristics L1′.

The suction flow rate is maintained at a prescribed flow rate Q0′ in a prescribed range (between stroke positions S4 to Smax) of the stroke position S that includes the stroke end during the expansion operation in the flow rate reduction characteristics. The prescribed flow rate Q0′ is equal to or less than the maximum discharge flow rate Qcmax of the charge pump 28 and greater than zero. The prescribed flow rate Q0′ in the flow rate reduction characteristics during an expansion operation may be the same as the prescribed flow rate Q0 in the flow rate reduction characteristics during a contraction operation. Alternatively, the prescribed flow rate Q0′ in the flow rate reduction characteristics during an expansion operation may differ from the prescribed flow rate Q0 in the flow rate reduction characteristics during a contraction operation.

The hydraulic drive system 1 according to the present embodiment has the following features.

The pump control unit 24a in the flow rate reduction control reduces the suction flow rate so that the suction flow rate of the first hydraulic pump 12 and the second hydraulic pump 13 (or, the suction flow rate of the first hydraulic pump 12) is equal to or less than the maximum discharge flow rate Qcmax of the charge pump 28 when the stroke position S approaches the stroke end of the cylinder rod 14a. When the cylinder rod 14a reaches the stroke end and the suction pressure is reduced, the shortage of hydraulic fluid is replenished by hydraulic fluid from the charge pump 28. Since the suction flow rate of the first hydraulic pump 12 and the second hydraulic pump 13 (or, the suction flow rate of the first hydraulic pump 12) is reduced by the flow rate reduction control at this time, the amount of hydraulic fluid required for replenishing is smaller. Therefore, a shortage of hydraulic fluid can be replenished with hydraulic fluid from the charge pump 28 without making the charge pump 28 larger. As a result, the occurrence of a supply shortage of hydraulic fluid to the first hydraulic pump 12 and the second hydraulic pump 13 (or, hydraulic fluid to the first hydraulic pump 12) and an increase in the size of the charge pump 28 can be suppressed.

Since the suction flow rate is reduced in accompaniment to the stroke position S approaching the stroke end in the flow rate reduction characteristics illustrated in FIG. 3, it can be suppressed that the movement of the hydraulic cylinder 14 become slow drastically. Moreover, since the change rate of the suction flow rate in the reduction portion of the flow rate reduction characteristics does not change regardless of the suction flow rate before the execution of the flow rate reduction control, variations in changes of the operation speed of the hydraulic cylinder 14 can be suppressed.

In the flow rate reduction characteristics illustrated in FIG. 3(a), hydraulic fluid of the prescribed flow rate Q0 is sucked into the first hydraulic pump 12 and the second hydraulic pump 13 even when the stroke position S has reached the stroke end. In the flow rate reduction characteristics illustrated in FIG. 3(b), hydraulic fluid of the prescribed flow rate Q0′ is sucked into the first hydraulic pump 12 even when the stroke position S has reached the stroke end. Therefore, the proximal end part of the cylinder rod 14 moves at a low speed and makes contact with the end part on the inside surface of the cylinder tube 14b. As a result, the operator is able to easily know when the stroke position S reaches the stroke end.

The suction flow rate is controlled according to different flow rate reduction characteristics during an expansion operation and during a contraction operation of the hydraulic cylinder 14. As a result, the suction flow rate can be controlled with flow rate reduction characteristics that suit the operating state of the hydraulic cylinder 14. For example, the flow rate of hydraulic fluid returning from the hydraulic cylinder 14 to the first hydraulic pump 12 and the second hydraulic pump 13 differs depending on whether the hydraulic cylinder 14 is in an expansion operation or a contraction operation. Therefore, the control of a suction flow rate suited to the flow rate differences can be performed through the use of different flow rate reduction characteristics during an expansion operation or a contraction operation of the hydraulic cylinder 14.

Whether the cylinder rod is expanding or contracting can be determined according to both the operating direction of the operating member 46a and the moving direction of the cylinder rod 14a. As a result, suitable flow rate reduction characteristics can be selected even if for example the hydraulic cylinder 14 moved in a direction opposite the operating direction of the operating member 46a due to inertia immediately after the operating direction of the operating member 46a is switched to the opposite direction.

Although an embodiment of the present invention has been described so far, the present invention is not limited to the above embodiments and various modifications may be made within the scope of the invention.

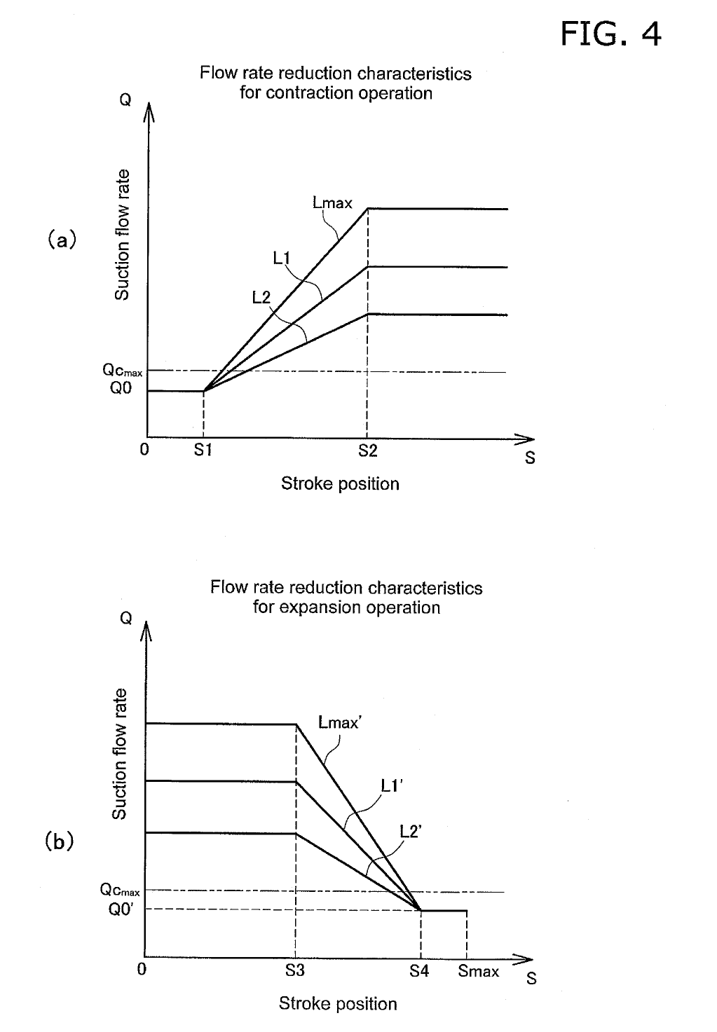

For example, flow rate reduction characteristics different from the flow rate reduction characteristics illustrated in FIG. 3 may be used. FIG. 4 illustrates graphs describing flow rate reduction characteristics according to a first modified example. FIG. 4(a) illustrates flow rate reduction characteristics during a contraction operation. FIG. 4(b) illustrates flow rate reduction characteristics during an expansion operation.

The change rate of the suction flow rate in the reduction portion of the flow rate reduction characteristics changes in response to the suction flow rate before the execution of the flow rate reduction control as illustrated in FIG. 4(a). Specifically, the size of the slope of the flow rate reduction characteristics L1 is smaller than the size of the slope of the flow rate reduction characteristics Lmax. The size of the slope of the flow rate reduction characteristics L2 is smaller than the size of the slope of the flow rate reduction characteristics L1. The change rate of the suction flow rate in the reduction portion of the flow rate reduction characteristics becomes smaller as the suction flow rate before the execution of the flow rate reduction control becomes smaller.

Moreover, the stroke position S when the reduction of the suction flow rate has started is the same regardless of the suction flow rate before the execution of the flow rate reduction control. Specifically, the reduction in the suction flow rate is started at any of the reduction start positions S2 for the flow rate reduction characteristics Lmax, the flow rate reduction characteristics L1, and the flow rate reduction characteristics L2. The suction flow rate reaches the prescribed flow rate Q0 that is equal to or less than the maximum discharge flow rate Qcmax of the charge pump 28 at the same stroke position S for the flow rate reduction characteristics Lmax, the flow rate reduction characteristics L1, and the flow rate reduction characteristics L2. Specifically, the suction flow rate reaches the prescribed flow Q0 at any of the reference positions S1 for the flow rate reduction characteristics Lmax, the flow rate reduction characteristics L1, and the flow rate reduction characteristics L2.

The change rate of the suction flow rate in the reduction portion of the flow rate reduction characteristics changes in response to the suction flow rate before the execution of the flow rate reduction control as illustrated in FIG. 4(b) in the same way as the flow rate reduction characteristics illustrated in FIG. 4(a). Specifically, the size of the slope of the flow rate reduction characteristics L1′ is smaller than the size of the slope of the flow rate reduction characteristics Lmax′. The size of the slope of the flow rate reduction characteristics L2′ is smaller than the size of the slope of the flow rate reduction characteristics L1′. The change rate of the suction flow rate in the reduction portion of the flow rate reduction characteristics becomes smaller as the suction flow rate before the execution of the flow rate reduction control becomes smaller.

Moreover, the stroke position S when the reduction of the suction flow rate has started is the same regardless of the suction flow rate before the execution of the flow rate reduction control. Specifically, the reduction in the suction flow rate is started at any of the reduction start positions S3 for the flow rate reduction characteristics Lmax′, the flow rate reduction characteristics L1′, and the flow rate reduction characteristics L2′. The suction flow rate reaches the prescribed flow rate Q0′ that is equal to or less than the maximum discharge flow rate Qcmax of the charge pump 28 at the same stroke position S for the flow rate reduction characteristics Lmax′, the flow rate reduction characteristics L1′, and the flow rate reduction characteristics L2′. Specifically, the suction flow rate reaches the prescribed flow Q0′ at any of the reference positions S4 for the flow rate reduction characteristics Lmax′, the flow rate reduction characteristics L1′, and the flow rate reduction characteristics L2′. Other features of the flow rate reduction characteristics according to the first modified example are the same as those of the flow rate reduction characteristics according to the above embodiment.

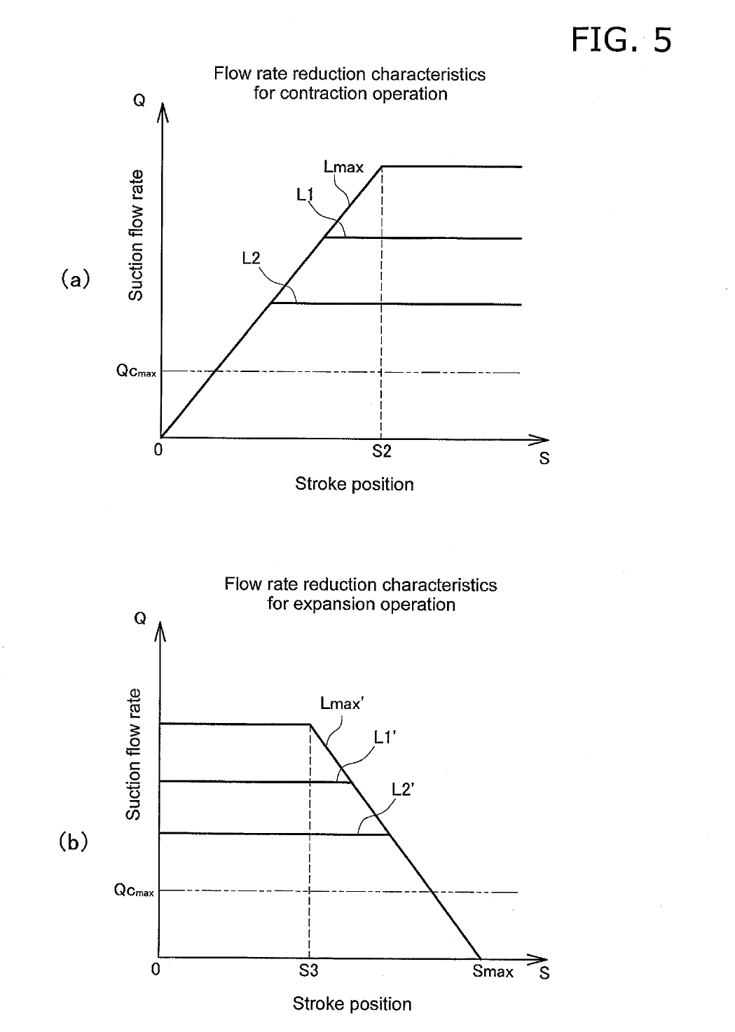

FIG. 5 illustrates graphs describing flow rate reduction characteristics according to a second modified example. FIG. 5(a) illustrates flow rate reduction characteristics during a contraction operation. FIG. 5(b) illustrates flow rate reduction characteristics during an expansion operation. As illustrated in FIG. 5(a), the suction flow rate reaches zero when the stroke position S reaches the stroke end during a contraction operation for the flow rate reduction characteristics Lmax, L1, and L2. Specifically, the suction flow rate reaches zero at the same time that the stroke position S reaches the stroke end during a contraction operation. As illustrated in FIG. 5(b), the suction flow rate reaches zero when the stroke position S reaches the stroke end during an expansion operation for the flow rate reduction characteristics Lmax′, L1′, and L2′. Specifically, the suction flow rate reaches zero at the same time that the stroke position S reaches the stroke end during an expansion operation. Other features of the flow rate reduction characteristics according to the second modified example are the same as those of the flow rate reduction characteristics according to the above embodiment.

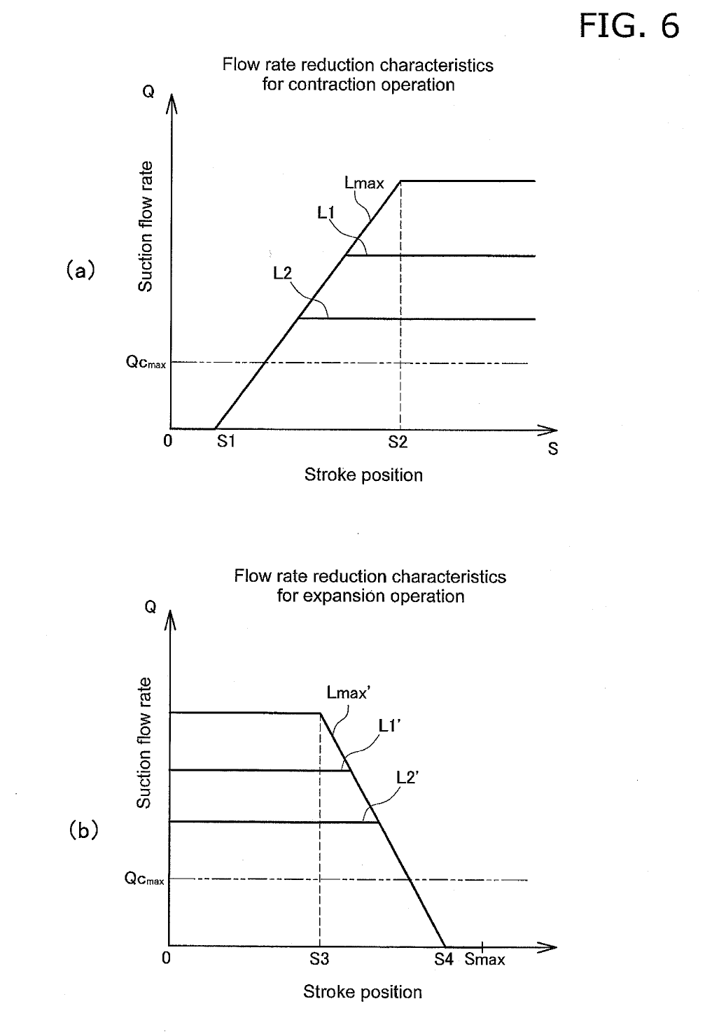

FIG. 6 illustrates graphs describing flow rate reduction characteristics according to a third modified example. FIG. 6(a) illustrates flow rate reduction characteristics during a contraction operation. FIG. 6(b) illustrates flow rate reduction characteristics during an expansion operation. As illustrated in FIG. 6(a), the suction flow rate reaches zero before the stroke position S reaches the stroke end during a contraction operation for the flow rate reduction characteristics Lmax, L1, and L2 during the contraction operation. Specifically, the suction flow rate reaches zero when the stroke position S reaches the reference position S1 during a contraction operation for the flow rate reduction characteristics Lmax, L1, and L2 during the contraction operation. As illustrated in FIG. 6(b), the suction flow rate reaches zero before the stroke position S reaches the stroke end during an expansion operation for the flow rate reduction characteristics Lmax′, L1′, and L2′ during the expansion operation. Specifically, the suction flow rate reaches zero when the stroke position S reaches the reference position S4 during a contraction operation for the flow rate reduction characteristics Lmax′, L1′, and L2′ during the contraction operation. Other features of the flow rate reduction characteristics according to the third modified example are the same as those of the flow rate reduction characteristics according to the above embodiment.

The flow rate reduction characteristics according to the first modified example may be corrected so that the suction flow rate reaches zero when the stroke position S reaches the stroke end during a contraction operation in the same way as the flow rate reduction characteristics according to the second modified example. Alternatively, the flow rate reduction characteristics according to the first modified example may be corrected so that the suction flow rate reaches zero before the stroke position S reaches the stroke end during a contraction operation in the same way as the flow rate reduction characteristics according to the third modified example.

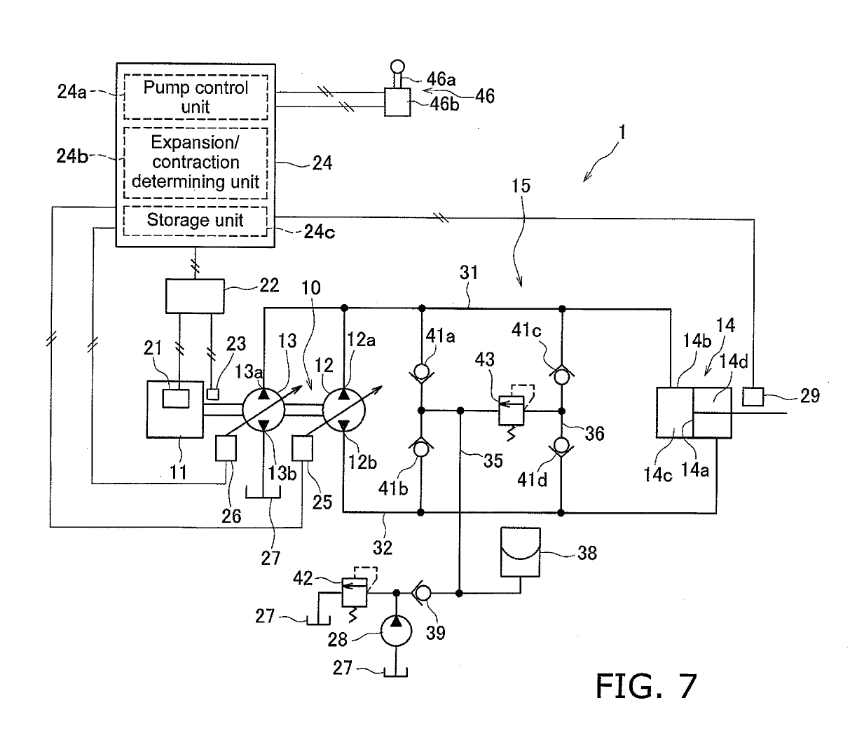

The configuration of the hydraulic drive system 1 is not limited to the configuration of the hydraulic drive system 1 described above. For example, as illustrated in FIG. 7, an accumulator 38 may be connected to the charge path 35. The accumulator 38 is connected to the charge pump 28 via a check valve 39. The check valve 39 allows the flow of hydraulic fluid from the charge pump 28 toward the accumulator 38 and prohibits the flow of hydraulic fluid from the accumulator 38 toward the charge pump 28 in the charge path 35. Hydraulic fluid can be replenished to the charge path 35 with hydraulic fluid stored in the accumulator 38. As a result, an increase in the size of the charge pump 28 can be further suppressed.

While the present invention is applicable to a twin pump hydraulic drive system in which two hydraulic pumps 12 and 13 are connected to the hydraulic cylinder 14 in the above embodiment, the present invention may also be applicable to a single pump hydraulic drive system in which one hydraulic pump is connected to the hydraulic cylinder 14. The driving source is not limited to an engine and may be an electric motor. In this case, a fixed displacement hydraulic pump may be used for the hydraulic pump in place of the variable displacement hydraulic pumps such as the abovementioned hydraulic pumps 12 and 13. The suction flow rate of the fixed displacement hydraulic pump may be controlled by controlling the rotation speed of the electric motor.

While the flow rate reduction control is executed for both the expansion operation and the contraction operation in the above embodiment, the flow rate reduction control may also be executed for either one of the expansion operation or the contraction operation

A hydraulic drive system that is able to suppress the generation of a supply shortage of hydraulic fluid to a hydraulic pump and suppress an increase in the size of a charge pump can be provided according to the present invention.

1. A hydraulic driving system comprising:
a hydraulic cylinder including a cylinder tube and a cylinder rod having a proximal end part inserted inside the cylinder tube, the cylinder rod partitioning inside of the cylinder tube into a first chamber and a second chamber, the cylinder rod being configured to expand due to hydraulic fluid being supplied to the first chamber and hydraulic fluid being exhausted from the second chamber, the cylinder rod being configured to contract due to hydraulic fluid being supplied to the second chamber and hydraulic fluid being exhausted from the first chamber;
a main pump switchable between
a state of supplying hydraulic fluid to the first chamber and sucking in hydraulic fluid from the second chamber, and
a state of supplying hydraulic fluid to the second chamber and sucking in hydraulic fluid from the first chamber;
a hydraulic-fluid path connecting the first chamber and the main pump, the hydraulic-fluid path also connecting the second chamber and the main pump, the hydraulic-fluid path forming a closed circuit between the main pump and the hydraulic cylinder;
a charge pump configured to replenish hydraulic fluid in the hydraulic-fluid path;
a stroke position detecting unit configured to detect a stroke position of a proximal end part of the cylinder rod inside the cylinder tube; and
a pump control unit configured to execute a flow rate reduction control, the pump control unit being configured to reduce a suction flow rate of the main pump in the flow rate reduction control so that the suction flow rate is equal to or less than a maximum discharge flow rate of the charge pump when the stroke position is closer to a stroke end of the cylinder rod than a prescribed reference position.

2. The hydraulic drive system according to claim 1, wherein
the pump control unit is configured to control the suction flow rate in accordance with flow rate reduction characteristics that prescribe a change in the suction flow rate with respect to the stroke position in the flow rate reduction control;
the flow rate reduction characteristics have a reduction portion in which the suction flow rate becomes smaller as the stroke position approaches the stroke end; and
a change rate of the suction flow rate in the reduction portion of the flow rate reduction characteristics does not change regardless of a suction flow rate before execution of the flow rate reduction control.

3. The hydraulic drive system according to claim 2, wherein
the stroke position when the reduction of the suction flow rate has started is closer to the stroke end in correspondence to a reduction in the size of the suction flow rate before the execution of the flow rate reduction control.

4. The hydraulic drive system according to claim 1, wherein
the pump control unit is configured to control the suction flow rate in accordance with flow rate reduction characteristics that prescribe a change in the suction flow rate with respect to the stroke position in the flow rate reduction control;
the flow rate reduction characteristics have a reduction portion in which the suction flow rate is reduced as the stroke position approaches the stroke end; and
a change rate of the suction flow rate in the reduction portion of the flow rate reduction characteristics changes in response to a suction flow rate before an execution of the flow rate reduction control.

5. The hydraulic drive system according to claim 4, wherein
a change rate of the suction flow rate in the reduction portion of the flow rate reduction characteristics becomes smaller in correspondence to a reduction in the size of the suction flow rate before the execution of the flow rate reduction control.

6. The hydraulic drive system according to claim 5, wherein
the stroke position when the reduction of the suction flow rate has started is the same regardless of the suction flow rate before the execution of the flow rate reduction control.

7. The hydraulic drive system according to claim 2, wherein
the suction flow rate is maintained at a prescribed flow rate equal to or less than a maximum discharge flow rate of the charge pump in a prescribed range of the stroke position including the stroke end in the flow rate reduction characteristics.

8. The hydraulic drive system according to claim 2, wherein
the suction flow rate becomes smaller as the stroke position approaches the stroke end, and the suction flow rate reaches zero when the stroke position reaches the stroke end in the flow rate reduction characteristics.

9. The hydraulic drive system according to claim 2, wherein
the suction flow rate becomes smaller as the stroke position approaches the stroke end, and the suction flow rate reaches zero before the stroke position reaches the stroke end, in the flow rate reduction characteristics.

10. The hydraulic drive system claim 2, further comprising:
an expansion/contraction determining unit configured to determine whether the hydraulic cylinder is operating by expanding or contracting;
the pump control unit being configured to control the suction flow rate in accordance with the flow rate reduction characteristics for an expansion operation in the flow rate reduction control when the hydraulic cylinder is in an expansion operation; and
the pump control unit being configured to control the suction flow rate in accordance with the flow rate reduction characteristics for a contraction operation in the flow rate reduction control when the hydraulic cylinder is in a contraction operation.

11. The hydraulic drive system according to claim 10, further comprising:
an operating member configured to operate the hydraulic cylinder,
the expansion/contraction determining unit being configured
to determine whether the cylinder rod is moving in an expansion direction or a contraction direction from detection results of the stroke position detecting unit, and
when the moving direction of the cylinder rod matches the operation direction of the operating member, to determine that the cylinder rod is in the expansion operation or the contraction operation.

12. The hydraulic drive system according to claims 10, wherein
a flow rate of hydraulic fluid returning to the main pump from the hydraulic cylinder during a contraction operation is greater than a flow rate of hydraulic fluid returning to the main pump from the hydraulic cylinder during an expansion operation.
